(19) United States
(12) Patent Application Publication
(10) Pub. No.: US 2023/0367304 A1
(43) Pub. Date: Nov. 16, 2023

(54) STATE DETERMINATION DEVICE AND STATE DETERMINATION METHOD

(71) Applicant: FANUC CORPORATION, Yamanashi (JP)

(72) Inventors: Atsushi HORIUCHI, Yamanashi (JP); Hiroyasu ASAOKA, Yamanashi (JP); Kenjirou SHIMIZU, Yamanashi (JP)

(21) Appl. No.: 18/245,544

(22) PCT Filed: Oct. 1, 2021
(86) PCT No.: PCT/JP2021/036474

§ 371 Date: Mar. 16, 2023

(30) Foreign Application Priority Data
Oct. 5, 2020 (JP) 2020-168773

(51) Int. Cl. G05B 23/02

(52) U.S. Cl. CPC G05B 23/024; G05B 23/0281

(57) ABSTRACT

A state determination device includes: a data acquirer configured to acquire data related to an industrial machine; an estimator configured to perform estimation using a learning model based on the acquired data; and a statistical data calculator configured to calculate a statistical quantity in accordance with a predetermined statistical condition and uses the calculated statistical quantity to calculate a statistical estimation value corrected from the estimation value estimated by the estimator and, accordingly, can adapt a state determination result calculated by the learning model to a change in the operation status or the like of the industrial machine.

### RELATED APPLICATIONS

The present application is a National Phase of International Application No. PCT/JP2021/036474 filed Oct. 1, 2021, which claims priority to Japanese Application No. 2020-168773, filed Oct. 5, 2020.

### TECHNICAL FIELD

The present invention relates to a state determination device and a state determination method related to an industrial machine.

### BACKGROUND ART

Maintenance of industrial machines such as an injection molding machine is performed periodically or in the event of an anomaly. In maintenance of an industrial machine, a maintenance personnel uses a physical quantity indicating the operation state of the industrial machine recorded in advance during the operation of the industrial machine to determine whether or not there is an anomaly in the operation state of the industrial machine and performs maintenance work such as replacement of a component with the anomaly.

A case of an injection molding machine will be described below as an example. As maintenance work for a check-valve in an injection cylinder provided to the injection molding machine, a method of regularly pulling a screw out of the injection cylinder and directly measuring the dimension of the check-valve is known. In such a method, however, it is required to suspend production to perform measuring work, and this causes a problem of reduced productivity.

As a conventional art to solve such a problem, a known method is to indirectly detect the amount of wear on a check-valve in an injection cylinder and perform anomaly diagnosis without requiring an action to suspend production, such as pulling a screw out of the injection cylinder. In this method, anomaly diagnosis is performed by sensing the running torque applied to the screw and detecting a phenomenon of backflow of resin to the backside of the screw.

For example, Patent Literatures 1 and 2 disclose that an anomaly in the load of a drive unit, the resin pressure, and so on is determined by supervised machine learning. However, if incidental equipment such as a mold required for production or a production material such as resin is replaced or if the running or operation state of a machine varies, this causes a deviation between a measurement value obtained by the machine and training data used in machine learning, which causes a problem of not being able to make correct determination by machine learning.

Patent Literature 3 discloses that, for an abnormal-degree estimation value derived via machine learning, a correction coefficient associated with a machine model or a machine material for injection molding is used to derive a corrected abnormal-degree estimation value with respect to an abnormal-degree estimation value calculated by a single learning model. This enables the single learning model to be applied for general purposes to various machine models, incidental equipment, and production materials. However, it is necessary to prepare correction amounts corresponding to the incidental equipment and the production material in advance, and this requires adjustment work on these correction amounts.

### CITATION LIST

### Patent Literature

Patent Literature 1: Japanese Patent Laid-Open Publication No. 2017-030221
Patent Literature 2: Japanese Patent Laid-Open Publication No. 2017-202632
Patent Literature 3: Japanese Patent Laid-Open Publication No. 2020-044718

### SUMMARY OF INVENTION

### Technical Problem

As described above, to make correct determination even with such variation in incidental equipment such as a mold required for production or a production material such as resin, it is required to prepare a plurality of state determination devices or a plurality of learning models. Furthermore, if the running state or the operation state of a machine varies (for example, if the incidental equipment such as a mold required for production is replaced or the production material such as resin is replaced), a determination reference or a determination method for determining whether or not there is an anomaly is required to be changed in accordance with the variation, which results in poor work efficiency, higher cost, and low versatility.

This is because, when there is a replacement of incidental equipment (such as a mold, a mold temperature controller, and a resin drier) or a production material, a change of operation conditions (for example, a parameter and a screen setting value such as an injection speed and an injection pressure, and a program), suspension and restarting of an automatic operation, or occurrence of a transition or a change of the running state or the operation state, this causes a significant difference in abnormal degrees calculated by a learning model before and after the transition or the change, and this results in a situation where the accuracy in determination of the abnormal degree is deteriorated or correct determination is prevented.

Specifically, a measurement value obtained after the running state or the operation state has transitioned may be deviated compared to a measurement value (learning data) obtained when a learning model is created, an estimation value estimated by machine learning may have an offset (shift) generated in despite the fact that the current state is the normal state, and determination accuracy is thus deteriorated.

That is, to address various production environments or demands from an operator, a scheme to adapt a state determination result calculated by a learning model to a transition of the running state the operation state or the like of an industrial machine is desired.

### Solution to Problem

A state determination device according to the present invention solves the above problem by: estimating an abnormal degree by using a learning model that has learned abnormal degrees based on time-series data acquired from an industrial machine; at a timing that an event of a transition of the running state or the operation state of the industrial machine occurs, calculating a statistical quantity from a plurality of estimation values obtained before and after the event; deriving an estimation value (abnormal degree) corrected from the estimation value (abnormal degree) estimated by the learning model based on the calculated statistical quantity; and determining an abnormal degree by using the corrected estimation value.

Further, one aspect of the present invention is a state determination device for determining a state of an industrial machine, the state determination device includes: a data acquirer configured to acquire data related to the industrial machine; a learning model storage configured to store a learning model that learned an operation state of the industrial machine associated with data related to an industrial machine; an estimator configured to, based on the data acquired from the industrial machine by the data acquirer, estimate an estimation value related to the state of the industrial machine by using the learning model stored in the learning model storage; a statistical condition storage configured to, as a condition for calculating a statistical quantity from a plurality of the estimation values estimated by the estimator, store a statistical condition including a statistical function and the number of samples related to calculation of at least the statistical quantity; a statistical data calculator configured to calculate a statistical quantity in accordance with the statistical condition stored in the statistical condition storage and uses the calculated statistical quantity to calculate a statistical estimation value corrected from the estimation value estimated by the estimator; and a determination result output configured to output a result of determination of the state of the industrial machine based on the statistical estimation value, and the statistical data calculator configured to calculate a first statistical quantity calculated based on an estimation value estimated by the estimator before an event that occurred in the industrial machine and a second statistical quantity calculated based on an estimation value estimated by the estimator after the event and uses the calculated first statistical quantity and second statistical quantity and a predefined certain correction function to calculate a statistical estimation value corrected from the estimation value estimated by the estimator after the event.

Another aspect of the present invention is a state determination method for determining a state of an industrial machine, the state determination method performs steps of: acquiring data related to the industrial machine; using a learning model that learned an operation state of the industrial machine associated with data related to an industrial machine to estimate an estimation value related to the state of an industrial machine based on data acquired from the industrial machine in the step of acquiring; calculating a statistical quantity from a plurality of the estimation values in accordance with a statistical condition including at least a statistical function and the number of samples related to calculation of a statistical quantity and using the calculated statistical quantity to calculate a statistical estimation value corrected from the estimation values; and outputting a result of determination of the state of the industrial machine based on the statistical estimation value, and the step of calculating the statistical estimation value includes calculating a first statistical quantity calculated based on an estimation value estimated in the step of estimating before an event that occurred in the industrial machine and a second statistical quantity calculated based on an estimation value estimated in the step of estimating after the event and using the calculated first statistical quantity and second statistical quantity and a predefined certain correction function to calculate the statistical estimation value corrected from the estimation value estimated in the step of estimating after the event.

### Advantageous Effects of Invention

According to one aspect of the present invention, an estimation value estimated by a single learning model obtained in machine learning can be used for general purposes even when various changes in the running state or the operation state occur, and improved determination accuracy and robust determination in various states can be actualized.

### BRIEF DESCRIPTION OF DRAWINGS

FIG. 1 is a schematic hardware configuration diagram of a state determination device according to one embodiment.

FIG. 2 is a schematic configuration diagram of an injection molding machine.

FIG. 3 is a schematic function block diagram of the state determination device according to a first embodiment.

FIG. 4 is a diagram illustrating an example of a molding cycle for manufacturing a single molded article.

FIG. 5 is a diagram of plots of estimation values according to a state of the injection molding machine estimated by a machine learning device.

FIG. 6 is a diagram illustrating an example of statistical conditions.

FIG. 7 is a diagram illustrating sections for respective estimation values indicated in the statistical conditions.

FIG. 8 is a diagram illustrating an example of corrected statistical estimation values.

FIG. 9 is a diagram illustrating an example of an input screen of statistical conditions.

### DESCRIPTION OF EMBODIMENTS

Embodiments of the present invention will be described below with reference to the drawings.

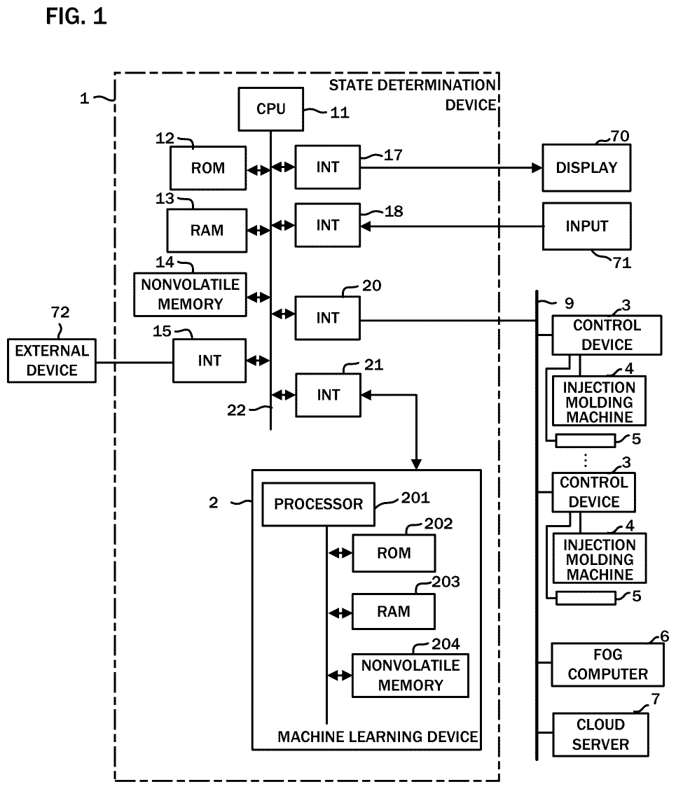

FIG. 1 is a schematic hardware configuration diagram of a state determination device according to one embodiment of the present invention.

A state determination device 1 according to the present embodiment can be implemented as, for example, a control device for controlling an industrial machine based on a control program, or can also be implemented in a higher-level device such as a personal computer provided together with a control device for controlling an industrial machine based on a control program or implemented in a personal computer, a cell computer, a fog computer 6, a cloud server 7, or the like connected via a wired/wireless network to the control device. In the present embodiment, an example in which the state determination device 1 is implemented on a personal computer connected via a network 9 to one or more control devices 3 is illustrated. Note that an industrial machine targeted for the state determination by the state determination device of the present invention may be, for example, an injection molding machine, a machine tool, a mining machine, a woodworking machine, an agricultural machine, a construction machine, or the like. In the following, an injection molding machine as one example of such industrial machines will be described.

A CPU 11 included in the state determination device 1 according to the present embodiment is a processor for controlling the state determination device 1 as a whole. The CPU 11 reads a system program stored in a ROM 12 via a bus 22 and controls the overall state determination device 1 in accordance with the system program. A RAM 13 temporarily stores transitory calculation data and display data, externally input various data, and the like.

A nonvolatile memory 14 is configured by a memory, a solid state drive (SSD), or the like backed up by a battery, not shown, and the storage state thereof is maintained even when the state determination device 1 is powered off. The nonvolatile memory 14 stores data loaded from an external device 72 via an interface 15, data input from an input device 71 via an interface 18, data acquired from one or more injection molding machines 4 via the network 9, or the like. The data to be stored may include data related to physical quantities such as motor current, a voltage, torque, a position, a velocity, or an acceleration of the drive unit, a pressure inside a mold, a temperature of an injection cylinder, a resin flow rate, a resin flow velocity, vibration or sound of the drive unit, or the like detected by various sensors 5 attached to the injection molding machine 4 controlled by the control device 3, for example. The data stored in the nonvolatile memory 14 may be loaded into the RAM 13 during execution or during use. Further, various system programs such as a known analysis program have been written in the ROM 12 in advance.

The interface 15 is an interface for connecting the CPU 11 in the state determination device 1 and the external device 72 such as an external storage device to each other. For example, a system program, a program, parameters, or the like related to the operation of the injection molding machine 4 can be loaded from the external device 72. Further, data or the like created or edited on the state determination device 1 can be stored in an external storage medium (not shown) such as a CF card, a USB memory, or the like via the external device 72.

The interface 20 is an interface for connecting the CPU in the state determination device 1 and the wired or wireless network 9 to each other. For example, the network 9 may be a network where any technology such as serial communication of RS-485 or the like, Ethernet (registered trademark) communication, optical communication, wireless LAN, Wi-Fi (registered trademark), Bluetooth (registered trademark), or the like may be used in communication. The control device 3 for controlling the injection molding machine 4, the fog computer 6, the cloud server 7, and the like are connected to the network 9 and transfer data to and from the state determination device 1.

Individual data loaded onto the memory, data obtained as a result of execution of a program or the like, data output from a machine learning device 2 described later, or the like are output via the interface 17 to a display device 70 and displayed on the display 70. Further, the input 71 configured by a keyboard, a pointing device, or the like passes instructions, data, or the like, which are based on an operator operation, via the interface 18 to the CPU 11.

An interface 21 is an interface for connecting the CPU 11 and the machine learning device 2 to each other. The machine learning device 2 includes a processor 201 for controlling the overall machine learning device 2, a ROM 202 storing a system program or the like, a RAM 203 used in temporary storage in each process related to machine learning, and a nonvolatile memory 204 used for storage of a learning model or the like. The machine learning device 2 can observe data (for example, data related to physical quantities such as motor current, a voltage, torque, a position, a velocity, or an acceleration of the drive unit, a pressure inside a mold, a temperature of an injection cylinder, a resin flow rate, a resin flow velocity, and vibration or sound of the drive unit, detected by various sensors 5 attached to the injection molding machine 4) that can be acquired by the state determination device 1 via the interface 21. Further, the state determination device 1 acquires a process result output from the machine learning device 2 via the interface 21 and stores, displays, or transmits the acquired result via the network 9 or the like to another device.

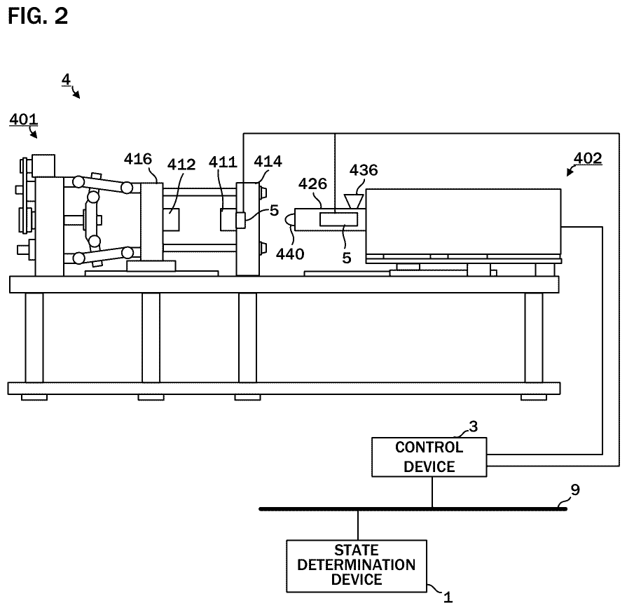

FIG. 2 is a schematic configuration diagram of the injection molding machine 4.

The injection molding machine 4 is configured mainly by a clamping unit 401 and an injection unit 402. The clamping unit 401 is provided with a movable platen 416 and a stationary platen 414. Further, a movable-side mold 412 is attached to the movable platen 416, and a stationary-side mold 411 is attached to the stationary platen 414. On the other hand, the injection unit 402 is configured by an injection cylinder 426, a hopper 436 for reserving a resin material to be supplied to the injection cylinder 426, and a nozzle 440 provided to the tip of the injection cylinder 426. In a molding cycle for manufacturing a single molded article, the movable platen 416 is moved to perform mold-closing and mold-clamping in the clamping unit 401, and the nozzle 440 is pressed against the stationary-side mold 411 and resin is then injected into the mold in the injection unit 402. These operations are controlled by instructions from the control device 3.

Further, the sensors 5 are attached to respective portions of the injection molding machines 4, and physical quantities such as motor current, a voltage, torque, a position, a velocity, or an acceleration of the drive unit, a pressure inside a mold, a temperature of the injection cylinder 426, a resin flow rate, a resin flow velocity, and vibration and sound of the drive unit are detected and transmitted to the control device 3. In the control device 3, each detected physical quantity is stored in a RAM, a nonvolatile memory, or the like, not shown, and transmitted via the network 9 to the state determination device 1 as needed.

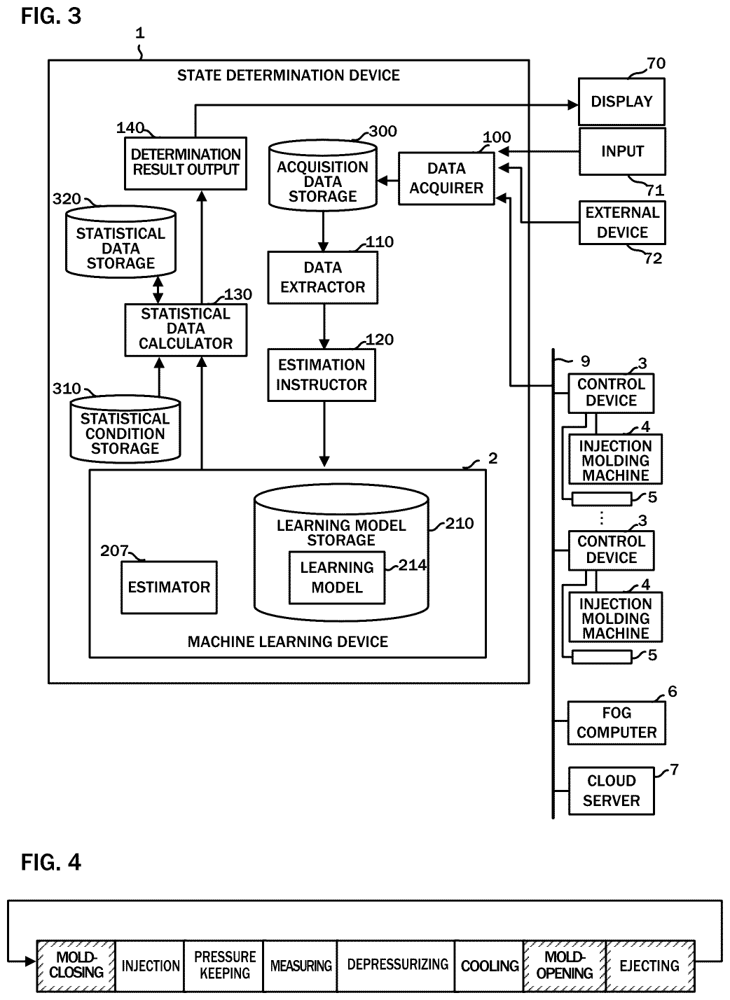

FIG. 3 illustrates functions of the state determination device 1 according to the first embodiment of the present invention as a schematic block diagram.

Each function of the state determination device 1 according to the present embodiment is implemented when the CPU 11 included in the state determination device 1 and the processor 201 included in the machine learning device 2 illustrated in FIG. 1 execute system programs, respectively, and control the operation of each unit of the state determination device 1 and the machine learning device 2.

The state determination device 1 of the present embodiment includes a data acquirer 100, a data extractor 110, an estimation instructor 120, a statistical data calculator 130, and a determination result output 140. Further, the machine learning device 2 includes an estimator 207. Furthermore, an acquisition data storage 300 as an area for storing data acquired from the control device 3 or the like by the data acquirer 100, a statistical condition storage 310 that stores in advance statistical conditions used in calculation of statistical data by the statistical data calculator 130, and a statistical data storage 320 as an area for storing statistical data calculated by the statistical data calculator 130 are prepared in the RAM 13 and the nonvolatile memory 14 in the state determination device 1. Further, in the RAM 203 or the nonvolatile memory 204 in the machine learning device 2, a learning model storage 210 is prepared as an area for storing a learning model 214 that has been created by a trainer described later and has learned correlation between data related to a predetermined physical quantity acquired from an industrial machine and a state related to the industrial machine.

The data acquirer 100 is implemented when the CPU 11 included in the state determination device 1 illustrated in FIG. 1 executes a system program read from the ROM 12 and thereby a computation process using the RAM 13 and the nonvolatile memory 14 performed mainly by the CPU 11 and an input control process performed by the interface 15, 18 and 20 take place. The data acquirer 100 acquires data related to physical quantities such as motor current, a voltage, torque, a position, a velocity, and an acceleration of the drive unit, a pressure inside a mold, a temperature of the injection cylinder 426, a resin flow rate, a resin flow velocity, vibration or sound of the drive unit, and so on detected by the sensors 5 attached to the injection molding machine 4. The data related to a physical quantity acquired by the data acquirer 100 may be so-called time-series data indicating values of the physical quantity for each predetermined cycle. Further, the data acquirer 100 may acquire an event that has occurred in the injection molding machine 4 (for example, replacement of a configuration, a material, or a mold, change of injection conditions, or implementation of maintenance), may directly acquire data from the control device 3 that controls the injection molding machine 4 via the network 9, may acquire data acquired by and stored in the external device 72, the fog computer 6, the cloud server 7, or the like, or furthermore, may acquire data related to respective physical quantities for each step of a single molding cycle performed by the injection molding machine 4.

FIG. 4 is a diagram exemplifying a molding cycle for manufacturing a single molded article. In FIG. 4, a mold-closing step, a mold-opening step, and an ejecting step that are steps in hatched blocks are performed in the operation of the clamping unit 401, and an injection step, a pressure keeping step, a measuring step, a depressurizing step, and a cooling step that are steps in white blocks are performed in the operation of the injection unit 402. The data acquirer 100 acquires data related to physical quantities so that the data can be distinguished for respective steps.

The data related to the physical quantities acquired by the data acquirer 100 are stored in the acquisition data storage 300.

The data extractor 110 is implemented when the CPU 11 included in the state determination device 1 shown in FIG. 1 executes a system program read from the ROM 12 and thereby a computation process using the RAM 13 and the nonvolatile memory 14 performed mainly by the CPU 11 takes place. The data extractor 110 extracts data used in a process related to machine learning, such as an estimation process performed by the machine learning device 2, via the acquisition data storage 300 from data related to the physical quantity acquired by the data acquirer 100. The data used in a process related to machine learning is data required for an estimation process or a learning process using a learning model used in the machine learning device 2, which may be data related to a single physical quantity or may be a combination of data related to a plurality of physical quantities. The data extractor 110 extracts data as appropriate in accordance with a learning model used by the machine learning device 2 in a process related to machine learning and outputs the extracted data to the estimation instructor 120.

The estimation instructor 120 is implemented when the CPU 11 included in the state determination device 1 shown in FIG. 1 executes a system program read from the ROM 12 and thereby a computation process using the RAM 13 and the nonvolatile memory 14 performed mainly by the CPU 11 and an input/output process using the interface 21 take place. The estimation instructor 120 instructs the machine learning device 2 to perform an estimation process by using a predetermined learning model.

The statistical data calculator 130 is implemented when the CPU 11 included in the state determination device 1 illustrated in FIG. 1 executes a system program read from the ROM 12 and thereby a computation process using the RAM 13 or the nonvolatile memory 14 performed mainly by the CPU 11 takes place. The statistical data calculator 130 calculates a predetermined statistical quantity by using estimation values of the state of the injection molding machine 4 output by the machine learning device 2 before and after a timing as a reference that a predetermined event is received from the injection molding machine 4. Each calculated statistical quantity and a predefined certain correction function are then used to calculate a statistical estimation value corrected from the estimation value for the state of the injection molding machine 4 output by the machine learning device 2 after event occurrence. The estimation value of the state of the injection molding machine 4 output by the machine learning device 2, the calculated statistical value, and the statistical estimation value are then stored in the statistical data storage 320, respectively.

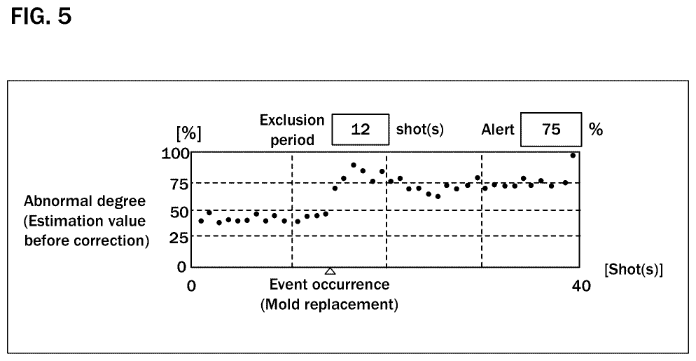

FIG. 5 is a diagram of plots of estimation values estimated by the machine learning device 2 before and after an event of mold replacement occurs.

As illustrated in FIG. 5, in response to a change of the running state or the operation state in the injection molding machine 4, a large transition occurs in the abnormal-degree estimation value estimated by the machine learning device 2 before and after the change. In the example of FIG. 5, the abnormal-degree estimation value estimated by the machine learning device 2 increases by about 35% in average from about 40% to about 75% before and after the mold replacement. Thus, as illustrated in FIG. 5, when the threshold to detect an anomaly as an alert is set at 75%, erroneous detection of the state as being abnormal may increase after the mold replacement even when no anomaly is occurring. Accordingly, a statistical quantity obtained before the event occurs (in the case of FIG. 5, the mean value before the event occurs) and a statistical quantity obtained after the event has occurred (in the case of FIG. 5, the mean value after the event has occurred) are calculated, each estimation value after the event has occurred is corrected based on the calculated statistical quantities. The state of the injection molding machine 4 is then determined based on the corrected estimation value (statistical estimation value), and thereby the probability of erroneous detection is reduced. In the example of FIG. 5, for example, by using a correction function to subtract the statistical quantity obtained after the event has occurred from the statistical quantity obtained before the event occurs and add the subtracted result to the corrected estimation value and then using the statistical estimation value corrected from each corrected estimation value, it is possible to continue detection of an abnormal state without changing the operation of the machine learning device 2 even after the mold replacement has occurred.

The statistical data calculator 130 calculates a predetermined statistical quantity before and after event occurrence by performing a predetermined statistical process in accordance with statistical conditions stored in the statistical condition storage 310. The predetermined event may be, for example, an event indicating that the running state or the operation state of the injection molding machine 4 has been changed, such as a mold replacement signal, an automatic operation start signal, a change of operation conditions (a parameter, a program), or the like.

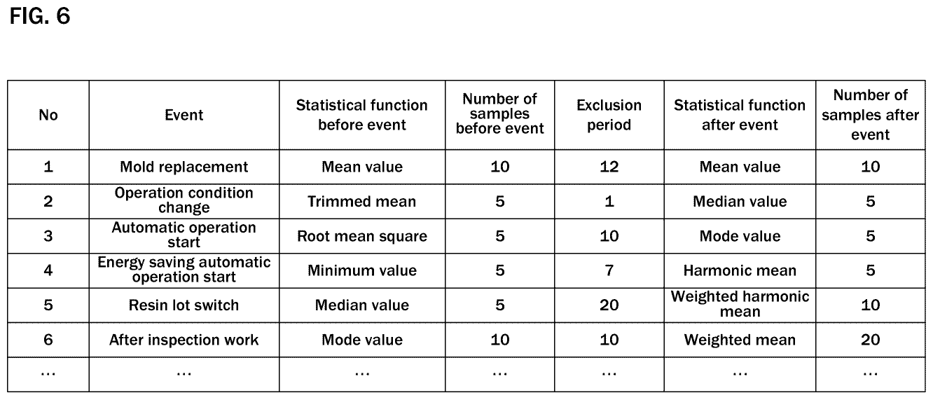

The statistical condition stored in the statistical condition storage 310 defines a condition to calculate a statistical quantity from a plurality of estimated results for the state of the injection molding machine 4 output by the machine learning device 2. FIG. 6 illustrates an example of statistical conditions stored in the statistical condition storage 310.

The statistical conditions include at least a statistical function used for calculation of a statistical quantity (a weighted mean (including an arithmetic mean), a weighted harmonic mean (including a harmonic mean), a trimmed mean, a root mean square, a minimum value, a maximum value, a mode value, a weighted median, or the like) and the number of samples of estimation values. Note that, in determining a statistical function defined in the statistical condition, it is preferable for the operator to visually check the distribution state of estimation values plotted in FIG. 5 and select a statistical function as appropriate. For example, when estimation values fluctuate with variation in a test operation of the injection molding machine 4 performed in advance, it is preferable to select an arithmetic mean, a harmonic mean, or the like as the statistical function for calculating the statistical quantity of these estimation values. Further, when, in a plurality of estimation values, an outlier that is significantly deviated from the mean value of the estimation values is included, it is preferable to select a mode value, a weighted median, or the like that are less likely to be affected by the outlier as the statistical function.

In the example of FIG. 6, statistical conditions are set for each predetermined event (replacement of incidental equipment (for example, mold replacement), change of an operation condition, change of a production material (for example, change of a resin lot), start of an automatic operation, end of inspection work, or the like) received from the injection molding machine 4. The statistical function and the number of samples (the total number of estimation values used for a statistical function) included in the statistical condition may include the statistical function and the number of samples used for calculating the statistical quantity before the event occurs and the statistical function and the number of samples used for calculating the statistical quantity after the event has occurred, respectively. Further, the number of estimation values not used for calculating the statistical quantity may be included as an exclusion period in the statistical condition. This exclusion period indicates a period from a time immediately after event occurrence to a time that the operation of the injection molding machine 4 becomes stable. A change of the running state or the operation state of the injection molding machine 4 may cause unstable fluctuation of estimation values estimated by the machine learning device 2 based on data related to a physical quantity acquired immediately after the change. Thus, an exclusion period is provided immediately after event occurrence, estimation values estimated by the machine learning device 2 during the exclusion period is excluded from calculation of a statistical quantity. Accordingly, an appropriate value can be calculated also for the statistical quantity after event occurrence.

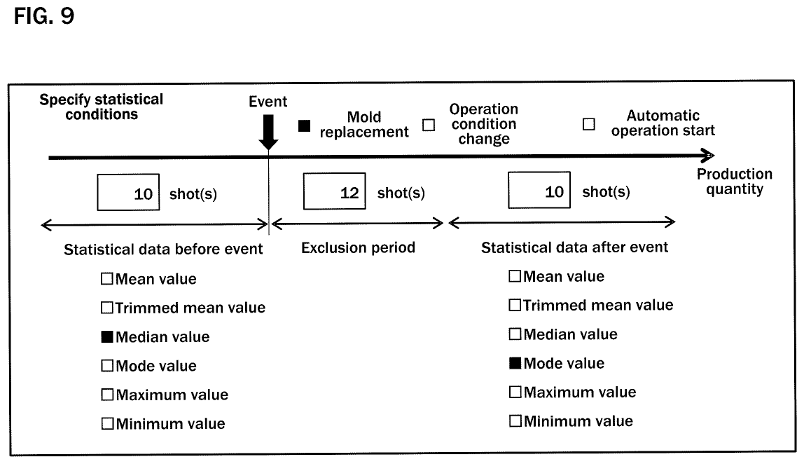

Note that the statistical conditions stored in the statistical condition storage 310 may be configured such that the statistical conditions can be manually set and updated via an operation of the input 71 from the operation screen displayed on the display 70, as illustrated in FIG. 9 as an example. The operation screen exemplified in FIG. 9 represents that the statistical condition storage 310 stores a statistical condition for, in response to occurrence of an event that mold replacement has taken place, calculating a median value from 10 estimation values estimated before receiving the event of the mold replacement, excluding 12 estimation values estimated after receiving the event of the mold replacement, and calculating a mode value from 10 estimation values estimated after the exclusion.

It is here assumed that the statistical conditions exemplified as an example in FIG. 6 are set. Once a predetermined event occurs, based on estimation values estimated before the event occurrence by the machine learning device 2, the statistical data calculator 130 calculates a statistical quantity resulted before the event occurrence. For example, in response to occurrence of an event that mold replacement defined in statistical condition No. 1 in FIG. 6 has taken place, the mean value is calculated from 10 estimation values estimated before the event of the mold replacement is received, and this mean value is determined as the statistical quantity resulted before the event occurrence. Further, based on estimation values obtained by removing estimation values in the exclusion period from the estimation values estimated by the machine learning device 2 after a predetermined event has occurred, the statistical data calculator 130 calculates a statistical quantity resulted after the event occurrence. For example, in response to occurrence of an event that mold replacement defined in statistical condition No. 1 in FIG. 6 has taken place, 12 estimation values estimated after the event of mold replacement has been received is excluded, the mean value is calculated from 10 estimation values estimated after the exclusion, and this mean value is determined as the statistical quantity resulted after the event occurrence.

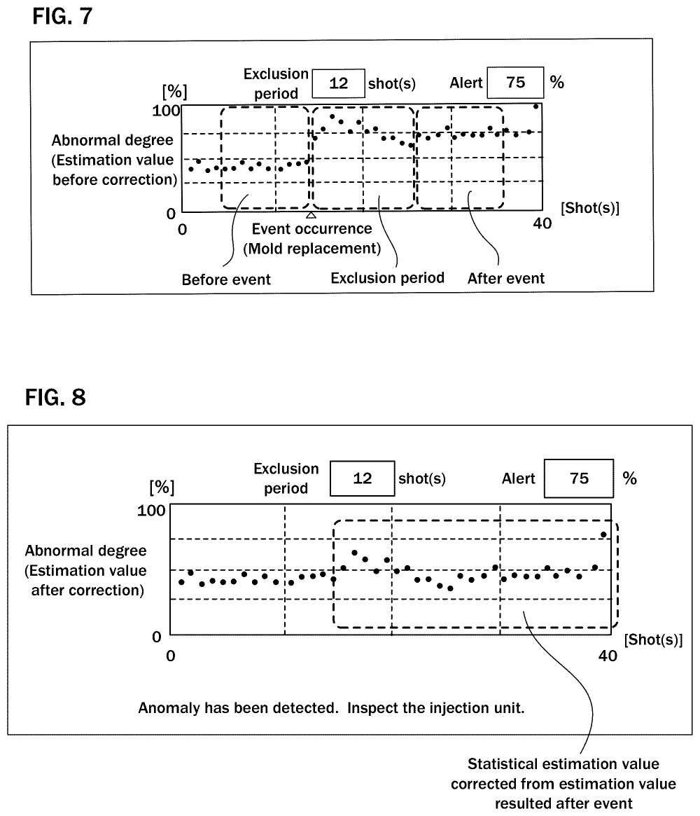

FIG. 7 is a diagram of plots of estimation values estimated by the machine learning device 2 illustrated in FIG. 5, and estimation values before an event, estimation values in the exclusion period, and estimation values after the event are indicated surrounded by dotted lines, respectively, in accordance with the statistical condition of FIG. 6. On the other hand, FIG. 8 is a diagram of plots of statistical estimation values corrected from abnormal-degree estimation values after an event based on statistical quantities before and after the event. In such a way, by correcting the estimation values obtained after an event based on statistical quantities before and after the event, it is possible to continue the determination of the state of the injection molding machine 4 without changing a reference (threshold) used in determining whether the state is abnormal or normal even without changing the operation of the machine learning device 2 or preparing a plurality of learning models in accordance with the running state or the operation state of the injection molding machine 4.

The determination result output 140 is implemented when the CPU 11 included in the state determination device 1 illustrated in FIG. 1 executes a system program read from the ROM 12 and thereby a computation process using the RAM 13 and the nonvolatile memory 14 performed mainly by the CPU 11 and an input/output process using the interface 17 and 20 take place. The determination result output 140 outputs information related to the state of the injection molding machine 4 estimated based on the statistical estimation value calculated by the statistical data calculator 130. The determination result output 140 may display and output, on the display device 70, information related to the state of the injection molding machine 4 estimated based on the statistical estimation value. For example, if the statistical estimation value exceeds a predefined abnormal-degree threshold, an alert message illustrated as an example in FIG. 8 “Anomaly has been detected. Inspect the injection unit.” may be displayed and output on the display 70. Furthermore, the operation of the injection molding machine may be suspended or decelerated, or the drive torque of a motor that drives the drive unit in the injection molding machine may be limited. Accordingly, it is possible to suspend the operation of the injection molding machine 4 before a molding failure increases, or it is possible to have a safe standby state to prevent damage of the injection molding machine 4. The determination result output 140 may transmit and output information related to the state of the injection molding machine 4 estimated based on the statistical estimation value to a higher-level device such as the control device 3 in the injection molding machine 4, the fog computer 6, or the cloud server 7 via the network 9.

On the other hand, the estimator 207 included in the machine learning device 2 is implemented when the processor 201 included in the machine learning device 2 illustrated in FIG. 1 executes a system program read from the ROM 202 and thereby a computation process using the RAM 203 or the nonvolatile memory 204 performed mainly by the processor 201 takes place. The estimator 207 performs an estimation process using the learning model 214 stored in the learning model storage 210 based on instructions from the estimation instructor 120 and outputs a result of the estimation to the statistical data calculator 130.

The learning model 214 is stored in advance in the learning model storage 210. The learning model 214 is created in advance and stored in the learning model storage 210. The learning model 214 has been trained based on data related to physical quantities acquired from the injection molding machine 4 in a predetermined running state or a predetermined operation state. The learning model used for state determination of the injection molding machine may be learning models created for respective steps (respective operation status) with training data determined by acquiring data related to physical quantities (for example, an injection speed and a pressure inside the mold in the injection step, and a screw rotation speed, screw torque, and a pressure inside the cylinder in the measuring step) that differ for respective steps (the injection step, the pressure keeping step, the measuring step, the depressurizing step, the cooling step, and the like) of the molding cycle. The estimation value estimated by using the learning model 214 may be, for example, power consumption for each step of the molding cycle, an abnormal degree related to quality of a molded article, or an amount of wear on a check-valve of an injection cylinder included in the injection molding machine 4, but is not limited to thereto and may be an index that can be used in determining whether or not there is an anomaly of the operation state of the injection molding machine 4.

The learning model used in state determination of the injection molding machine 4 may be created by a learning algorithm such as known supervised learning (multilayer perceptron, coupled recurrent neural network, convolutional neural network, or the like), unsupervised learning (autoencoder, k-means clustering, generative adversarial network, or the like), or reinforcement learning (Q-learning or the like). Further, components of learning algorithms (a type of hyperparameter such as a learning rate, a type of an optimization function during machine learning, or the like) for creating respective learning models may be configured based on a known technology. The learning models created by respective learning algorithms may differ in the calculation load during a learning process and an estimation process (calculation time), the accuracy of estimation values, the robustness against learning data (stability). It is thus preferable to select suitable learning algorithm in accordance with the purpose of state determination.

The learning model used in state determination related to an industrial machine may be stored in a compressed state in advance and then decompressed and used before computation. This enables efficient use of the memory or operation with a smaller capacity and therefore has an advantage of reduced cost. Further, the learning model may be encrypted and stored. Encrypting and storing a learning model is preferable in terms of security or information concealment.

The state determination device 1 according to the present embodiment having the above configuration can use estimation values resulted from a single learning model obtained by machine learning for general purposes even when various changes of the running state or the operation state occur and therefore actualizes improved determination accuracy and robust determination in various states. Further, since versatility of estimation values calculated by a learning model is increased, the working time and cost related to acquisition work of various measurement values (learning data) and creation work of a learning model can be reduced, and work efficiency can thus be improved.

As described above, although one embodiment of the present invention has been described, the present invention is not limited to only the examples of the embodiment described above and can be implemented in various manners with a suitable modification.

Although an example with an injection molding machine has been described in the above embodiment, a target of state determination may be another industrial machine. For example, in a machine tool, the abnormal degree of a spindle may be determined by a plurality of learning models associated with a cutting tool assembled to the spindle, the type or the flow rate of a processing liquid for cooling the cutting tool, the workpiece material, or the like. In a woodworking machine, the abnormal degree of a rotation tool may be determined by a plurality of learning models associated with the type, the rotation speed, or the like of the rotation tool. In an agricultural machine, the abnormal degree of the drive unit may be determined by a plurality of learning models associated with drive force applied to the drive unit, equipment provided to the drive unit, or the like. In a construction machine or a mining machine, the abnormal degree of a hydraulic cylinder may be determined by a plurality of learning models associated with, for example, the type of a hydraulic hose connected to the hydraulic cylinder, the motor output, or the operation environment. It is possible to determine an abnormal degree by using a statistical estimation value corrected from estimation values estimated by respective learning models in accordance with an event such as a change of operation conditions such as a speed related to the operation of respective industrial machines or replacement of incidental equipment.

Further, when a plurality of industrial machines are connected to each other via the network 9, data may be acquired from these industrial machines to determine the states of respective industrial machines by a single state determination device 1. Alternatively, state determination devices 1 may be arranged on respective control devices provided to the plurality of industrial machines to determine the states of respective industrial machines by using the state determination devices 1 provided to these industrial machines, respectively.

1. A state determination device for determining a state of an industrial machine, the state determination device comprising:
a data acquirer configured to acquire data related to the industrial machine;
a learning model storage configured to store a learning model that learned an operation state of the industrial machine associated with data related to an industrial machine;
an estimator configured to, based on the data acquired from the industrial machine by the data acquirer, estimate an estimation value related to the state of the industrial machine by using the learning model stored in the learning model storage;
a statistical condition storage configured to, as a condition for calculating a statistical quantity from a plurality of the estimation values estimated by the estimator, store a statistical condition including a statistical function and the number of samples related to calculation of at least the statistical quantity;
a statistical data calculator configured to calculate a statistical quantity in accordance with the statistical condition stored in the statistical condition storage and uses the calculated statistical quantity to calculate a statistical estimation value corrected from the estimation value estimated by the estimator; and
a determination result output configured to output a result of determination of the state of the industrial machine based on the statistical estimation value,
wherein the statistical data calculator configured to calculate a first statistical quantity calculated based on an estimation value estimated by the estimator before an event that occurred in the industrial machine and a second statistical quantity calculated based on an estimation value estimated by the estimator after the event and uses the calculated first statistical quantity and second statistical quantity and a predefined certain correction function to calculate a statistical estimation value corrected from the estimation value estimated by the estimator after the event.

2. The state determination device according to claim 1, wherein the event is at least one of replacement of incidental equipment, a change of an operation condition, a change of a production material, start of an automatic operation, or end of inspection work.

3. The state determination device according to claim 1, wherein the statistical function is to calculate any one of a weighted mean, an arithmetic mean, a weighted harmonic mean, a harmonic mean, a trimmed mean, a root mean square, a minimum value, a maximum value, a mode value, and a weighted median.

4. The state determination device according to claim 1,
wherein the statistical condition includes a predetermined exclusion period, and
wherein the statistical data calculator excludes estimation values included in the predetermined exclusion period from the estimation value estimated by the estimator after the event and then calculates the second statistical quantity.

5. The state determination device according to claim 1, wherein the correction function is to subtract the second statistical quantity from the first statistical quantity and add a result of the subtraction to the estimation value estimated by the estimator after the event.

6. The state determination device according to claim 1, wherein the learning model was trained by at least one learning method from supervised learning, unsupervised learning, and reinforcement learning.

7. The state determination device according to claim 1, wherein a result of determination output by the determination result output is displayed and output on a display.

8. The state determination device according to claim 1, wherein when the state of the industrial machine is determined as abnormal, the determination result output outputs at least any one of a signal to suspend operation of the industrial machine, a signal to decelerate operation of the industrial machine, or a signal to limit drive torque of a motor driving the industrial machine.

9. The state determination device according to claim 1, wherein the data acquirer is connected to a plurality of industrial machines via a wired or wireless network and acquires data from the plurality of industrial machines.

10. The state determination device according to claim 1, wherein the state determination device is implemented on a higher-level device connected to the industrial machine via a wired or wireless network.

11. A state determination method for determining a state of an industrial machine, the state determination method performing steps of:
acquiring data related to the industrial machine;
using a learning model that learned an operation state of the industrial machine associated with data related to an industrial machine to estimate an estimation value related to the state of the industrial machine based on data acquired from the industrial machine in the step of acquiring;
calculating a statistical quantity from a plurality of the estimation values in accordance with a statistical condition including at least a statistical function and the number of samples related to calculation of a statistical quantity and using the calculated statistical quantity to calculate a statistical estimation value corrected from the estimation values; and
outputting a result of determination of the state of the industrial machine based on the statistical estimation value,
wherein the step of calculating the statistical estimation value includes
calculating a first statistical quantity calculated based on an estimation value estimated in the step of estimating before an event that occurred in the industrial machine and a second statistical quantity calculated based on an estimation value estimated in the step of estimating after the event, and
using the calculated first statistical quantity and second statistical quantity and a predefined certain correction function to calculate the statistical estimation value corrected from the estimation value estimated in the step of estimating after the event.
